(19) United States
(12) Patent Application Publication
(10) Pub. No.: US 2014/0134864 A1
(43) Pub. Date: May 15, 2014

(54) CONNECTOR

(71) Applicant: YAZAKI CORPORATION, Tokyo (JP)

(72) Inventor: Shinji MOCHIZUKI, Shizuoka (JP)

(73) Assignee: YAZAKI CORPORATION, Tokyo (JP)

(21) Appl. No.: 14/140,605

(22) Filed: Dec. 26, 2013

Related U.S. Application Data
(63) Continuation of application No. PCT/JP2012/003999, filed on Jun. 20, 2012.

(30) Foreign Application Priority Data
Jun. 30, 2011 (JP) 2011-145312

(51) Int. Cl. H01R 13/64

(52) U.S. Cl. CPC H01R 13/64
USPC 439/246; 439/676; 439/345

(57) ABSTRACT

A connector 1 includes a wire holder 3 to which wires 7 are attached and a unit part 5 having a connection part 9 into which the wire holder is inserted to connect the wires to solderless terminals 11 arranged at the connection part. The wire holder is divided into a plurality of divided holders 13 and 15. The divided holders 13 and 15 are joined together and are inserted into the connection part.

### CROSS REFERENCE TO RELATED APPLICATION

This application is a Continuation of PCT Application No. PCT/JP2012/003999, filed on Jun. 20,2012, and claims the benefit of priority under 35 U.S.C. 119(a) to Japanese Patent Application No. 2011-145312 filed on Jun. 30, 2011, the entire contents of which are incorporated by reference herein.

The present invention relates to a connector, and particularly, to a connector used for a car and the like.

As illustrated in FIG. 1, known connectors 202 and 204 arranged adjacent to each other have a fitting groove 210 and a mating part 212 on opposite side faces 206 and 208, respectively. The related art is disclosed in, for example, Japanese Unexamined Patent Application Publication No. 2001-52798.

The fitting groove 210 has a protrusion for preventing mismating 214 and the mating part 212 has a protrusion for preventing mismating. 216. The protrusions for preventing mismating 214 and 216 as keys each is provided so as to prevent the mismating of otherwise identical connector components.

If the connectors 202 and 204 are correctly oriented, the protrusions 214 and 216 engage with each other and the fitting groove 210 and mating part 212 engage with each other, to connect the connectors 202 and 204 to each other.

On the other hand, if the connectors 202 and 204 are incorrectly oriented, the protrusions 214 and 216 interfere with each other not to connect the connectors 202 and 204 to each other.

With this, the connectors are correctly and smoothly connected to each other.

The connectors 202 and 204 illustrated in FIG. 1 are, for example, female connectors and reference marks 218 and 220 of FIG. 1 indicate a plurality of recesses (male connector connecting parts) into which male connectors (not illustrated) are inserted and connected.

### SUMMARY

According to the connectors of the related art mentioned above, male connectors set at ends of wires must be inserted into the plurality of recesses 218 and 220 in a plurality of times. This connection technique takes time and involves a risk of incorrect insertion of the male connectors.

In consideration of the above-mentioned problems, the present invention provides a connector that is correctly and smoothly connectable to an opposite connector.

According to a technical aspect of the present invention, the connector has a wire holder to which wires are attached and a unit having a connection part into which the wire holder is inserted to connect the wires to solderless terminals arranged at the connection part. The wire holder is divided into a plurality of divided holders that are joined together and are inserted into the connection part.

### BRIEF DESCRIPTION OF DRAWING

FIG. 1 is a perspective view schematically illustrating connectors according to a related art.

FIG. 2 is a perspective view illustrating a connector according to an embodiment of the present invention with a wire holder inserted into a control unit.

FIG. 3 is a view illustrating a section II-II of FIG. 2.

FIG. 4 is a perspective view illustrating wires set in a second divided holder of the wire holder.

FIG. 5 is a perspective view illustrating a first divided holder with wires set therein and the second divided holder with wires set therein, the first and second divided holders being in a state before joined together.

FIG. 6 is a perspective view illustrating the control unit and wire holder before connected to each other.

FIG. 7 is an exploded perspective view illustrating the control unit.

FIG. 8 is a perspective view illustrating the first divided holder with wires set therein.

FIG. 9 is a perspective view illustrating the second divided holder with wires set therein.

FIG. 10 is a front view illustrating the wire holder made of the joined first and second divided holders with wires set therein.

FIG. 11 is a view illustrating a section XI-XI of FIG. 10.

FIG. 12 is a perspective view in the direction of an arrow XII of FIG. 11.

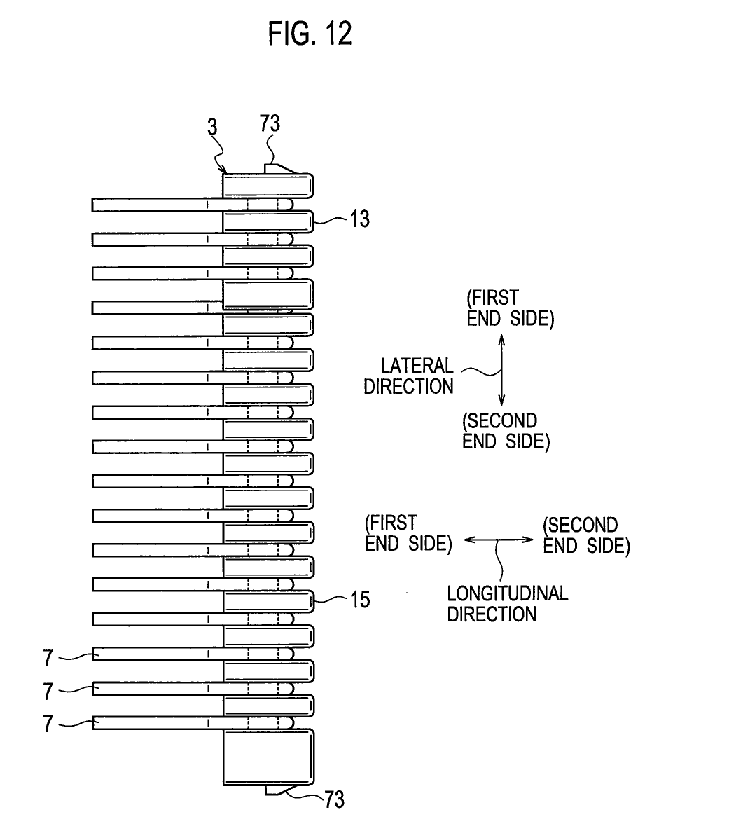

FIG. 13 is an enlarged view illustrating a part XIII of FIG. 11.

FIG. 14 is an enlarged view illustrating a part XIV of FIG. 5.

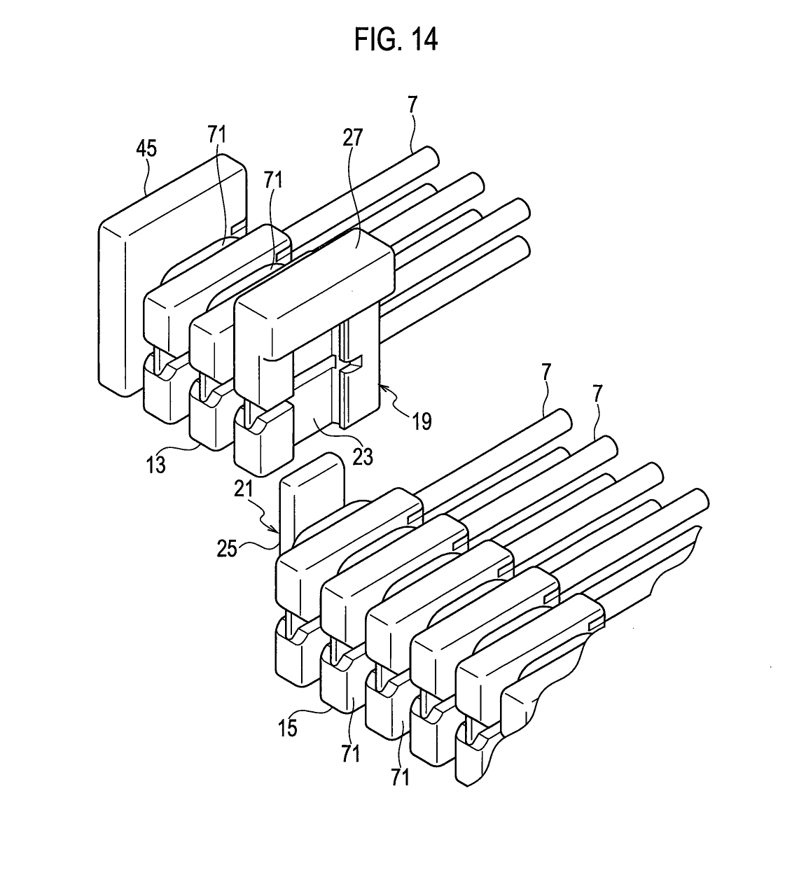

### DESCRIPTION OF EMBODIMENTS

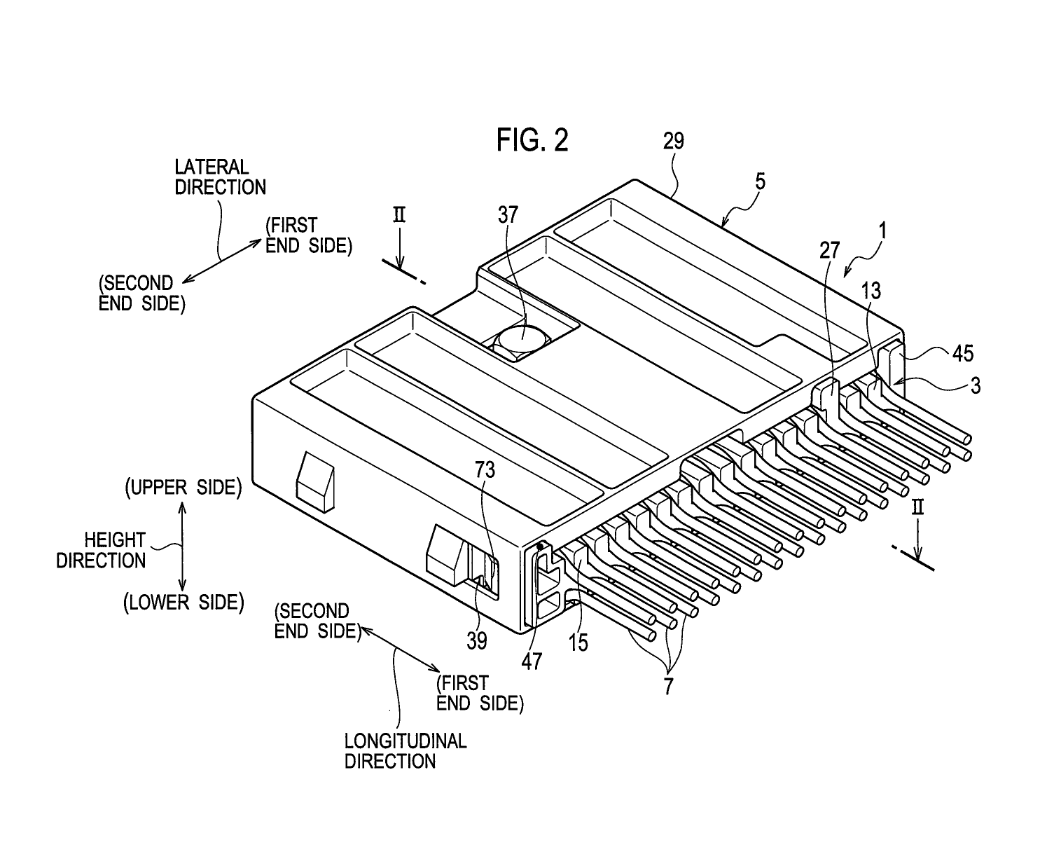

A connector (a pair of connectors) 1 according to an embodiment of the present invention includes, as illustrated in FIGS. 2, 3, 6, and the like, a wire holder (male connector) 3 and a unit part (such as a control unit, i.e., a female connector) 5. Wires 7 are attached to the wire holder 3. Namely, the wire holder 3 holds and fixes the wires 7.

The control unit 5 has a connection part 9. The wire holder 3 is inserted into the connection part 9 of the control unit 5, to connect the wire holder 3 to the control unit 5. In a state that the wire holder 3 is connected to the control unit 5, the wires 7 are connected to solderless terminals 11 arranged at the connection part 9 of the control unit 5.

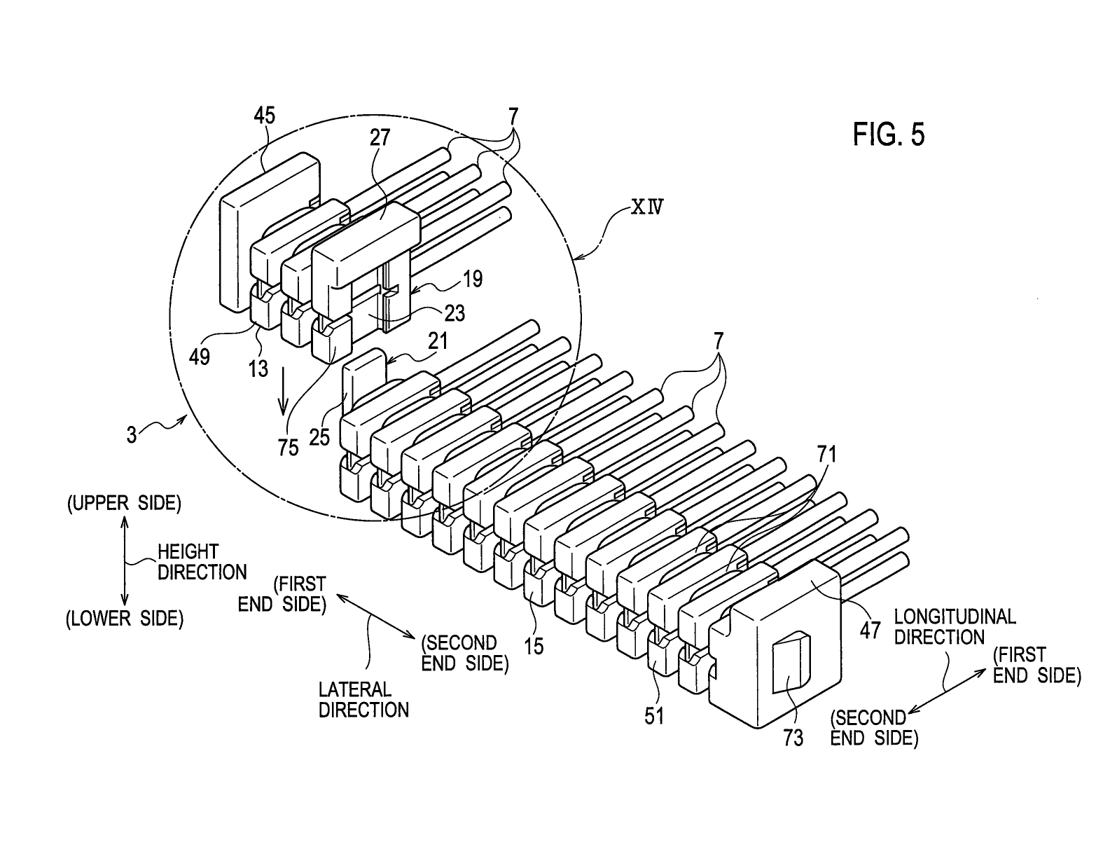

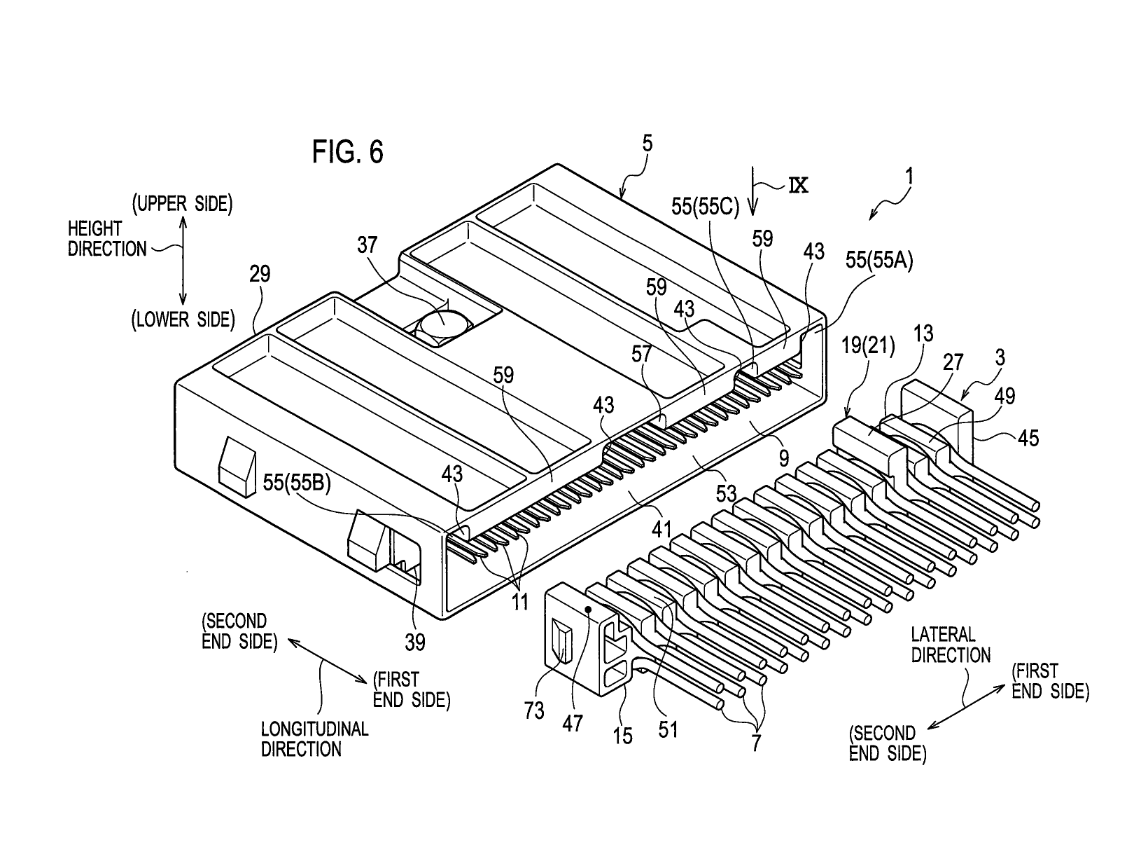

The wire holder 3 is dividable as illustrated in FIGS. 5, 6, and the like. A plurality of divided holders 13 and 15 such as divided wire holders or sub-harnesses are joined together into the wire holder 3, which is inserted into the connection part 9 of the control unit 5.

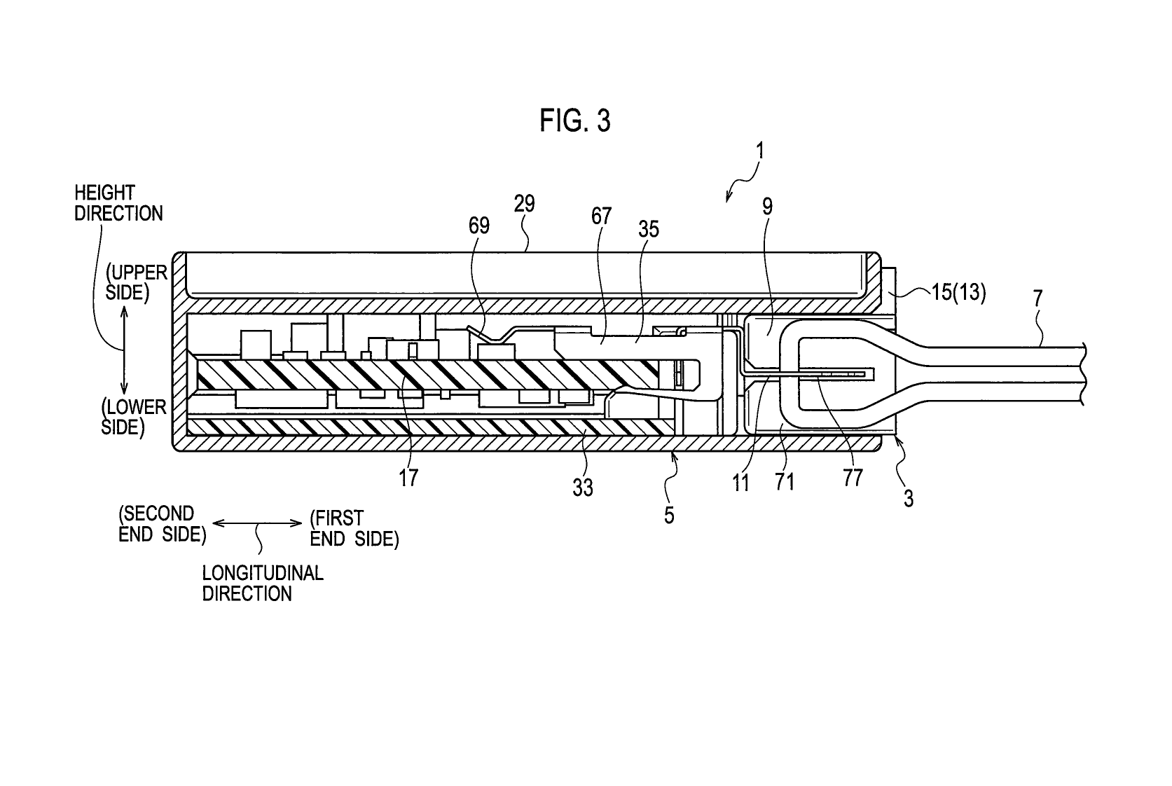

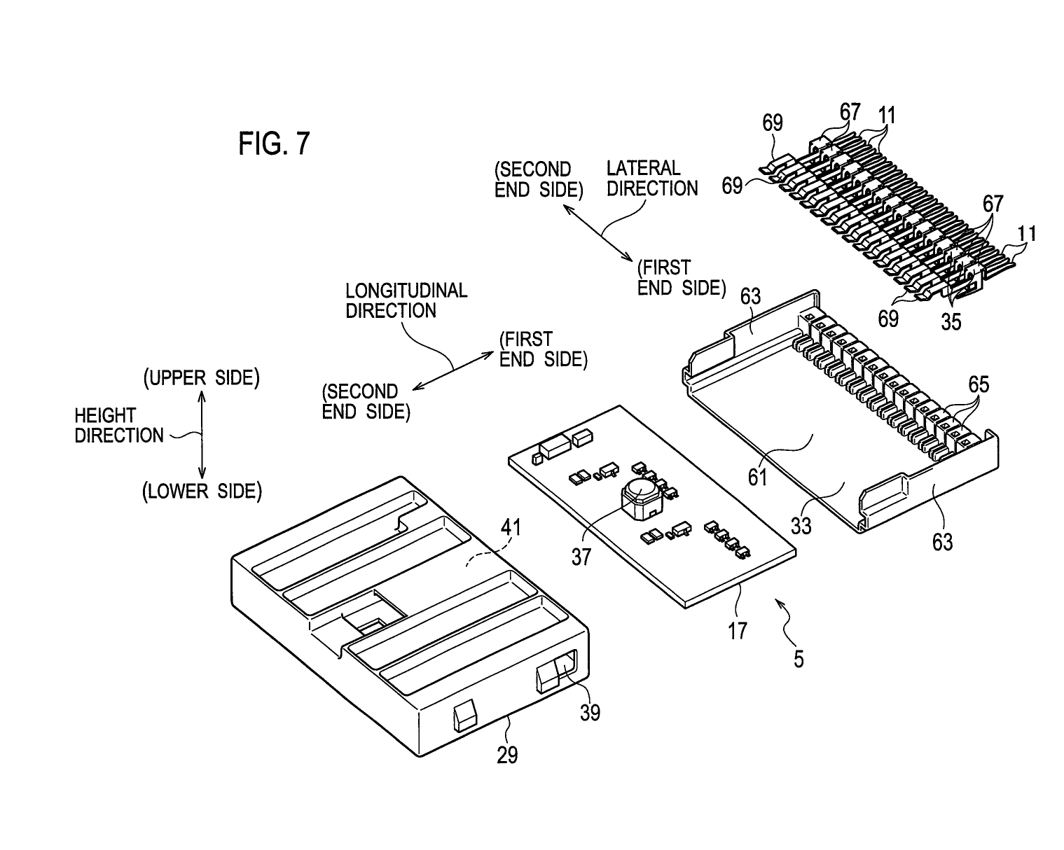

The control unit 5 has a control circuit board 17 as illustrated in FIGS. 3, 7, and the like. The wire holder 3 is configured to have a joint incorporating function to be explained later in detail. It is possible that the control unit 5 has the control circuit board 17 and the wire holder 3 is configured not to have the joint incorporating function so as to hold single wires. It is possible that the wire holder 3 has the joint incorporating function and the control unit 5 is not provided with the control circuit board 17 such as a simple female connector instead of the control unit 5.

In the connector 1, the first and second divided holders 13 and 15 are joined together with first and second divided holder joints 19 and 21, the joints 19 and 21 being formed on the divided holders 13 and 15, respectively, and having at least one of a pry preventing function and a mismating preventing function.

The pry is an action to apply force that generates torque around an engaging direction when the wire holder 3 is engaged to or disengaged from the connection part 9 of the control unit 5. The joint 21 joined at a location corresponding to the connection part 9 limits the pry action.

When the wire holder 3 is inserted into the connection part 9 of the control unit 5, the joints 19 and 21 combined to form a recessed joint structure 27 interfere with the connection part 9 in the case of an incorrect connection, thereby preventing the incorrect connection. This prevents a mismating such as an inverted insertion of the wire holder 3 into the control unit 5.

As illustrated in FIG. 5 or the like, the joint 19 of the first divided holder 13 between the divided holders 13 and 15 has a joint recess such as a rectangular parallelepiped recess 23 formed at an end of the first divided holder 13.

The joint 21 of the second divided holder 15, i.e., the other of the divided holders 13 and 15 has a joint protrusion such as a rectangular parallelepiped protrusion 25 formed at an end of the second divided holder 15.

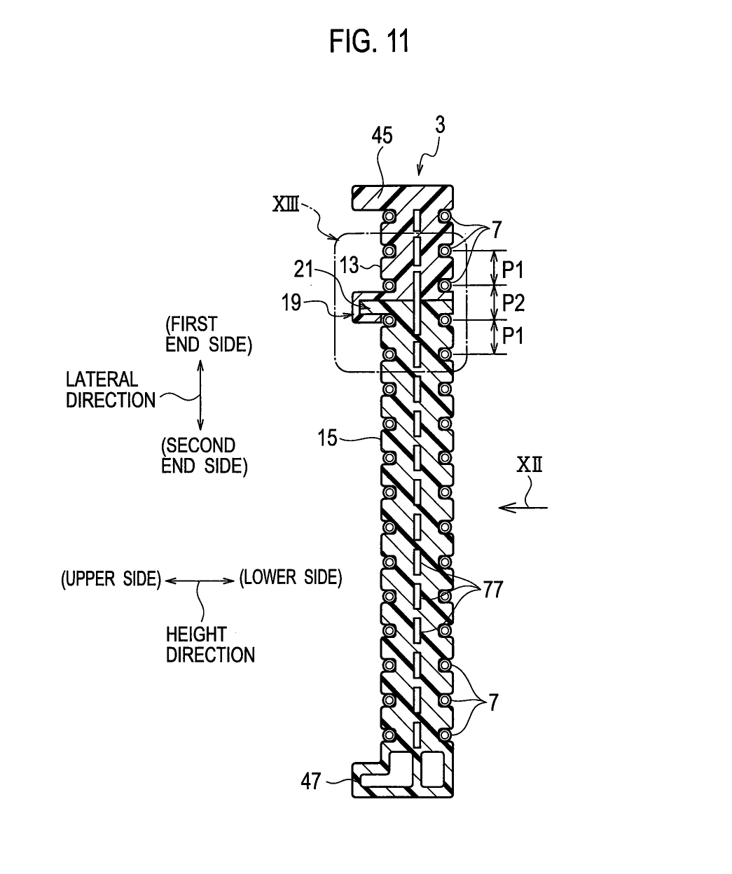

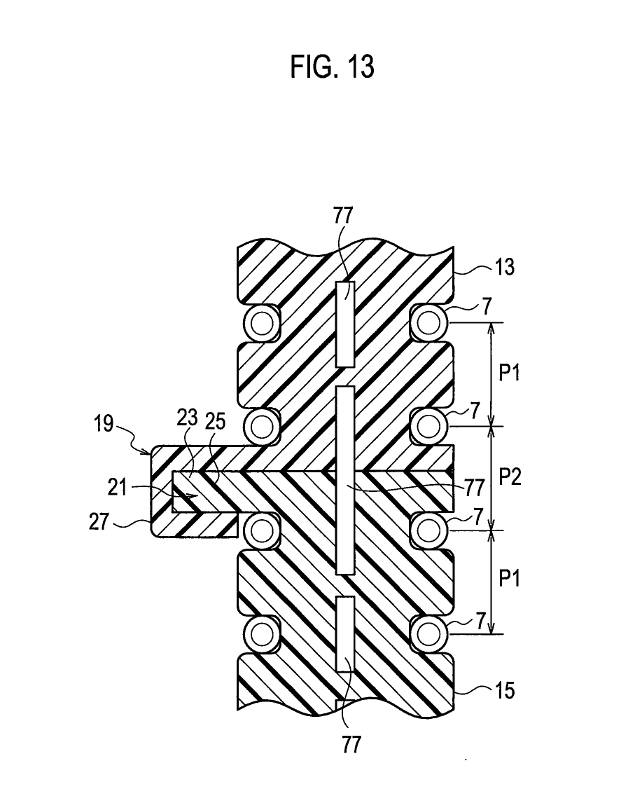

The joint protrusion 25 is inserted into the joint recess 23, to join the divided holders 13 and 15 together and form the wire holder 3 as illustrated in FIGS. 11, 13.

When the wire holder 3 is connected to the control unit 5, the recessed joint structure 27 (as illustrated in FIG. 6) having the joint recess 23 demonstrates at least one of the pry preventing function and mismating preventing function.

The connector 1 will be explained in detail with reference to examples.

For the sake of explanation, a width direction of the connector 1 is defined as a lateral direction, a direction which is orthogonal to the lateral direction and in which the wires 7 extend from the connection 1 is defined as a longitudinal direction, and a direction orthogonal to the lateral and longitudinal directions is defined as a height direction.

The connector 1 has, as illustrated in FIG. 6 or the like, the control unit 5 having a female connector function and the wire holder 3 having a male connector function.

The control unit 5 has, as illustrated in FIG. 7 or the like, a casing 29, the control circuit board 17 having a rectangular flat plate shape, a housing 33 such as a body on which the control circuit board and busbars are arranged, and the busbars 35.

The casing 29, housing 33, and wire holder 3 are made of nonconductive material such as synthetic resin. On the control circuit board 17, a switch 37, circuit elements, and terminals (not illustrated) are arranged. The busbars 35 are made of conductive material such as metal.

The casing 29 has a rectangular box shape having an open face at a first end in the longitudinal direction. Each wall of the casing 29 at an end in the lateral direction, i.e. at the first end in the longitudinal direction of the wall, has a latch hole 39 to latch the wire holder 3.

An opening 41 formed at the first end in the longitudinal direction of the casing 29 is the connection part 9 of the control unit 5. The opening 41 substantially has a rectangular shape surrounded with a substantial quadrilateral wall (solid part) when viewed in the longitudinal direction. The opening 41, however, partly has protrusions 43 to receive the end joints 45 and 47 and recessed joint structure 27 of the wire holder 3.

When viewed in the longitudinal, the opening 41 of the casing 29 has a large rectangular part 53 having a larger dimension in the lateral direction and a smaller dimension in the longitudinal direction in order to receive bodies 49 and 51 of the divided holders 13 and 15 and three small rectangular parts 55.

The three small rectangular parts 55 have substantially the same shape to receive the end joints 45 and 47 and the joints 19 and 21 (recessed joint structure 27) of the wire holder 3. A dimension in the height direction of the small rectangular parts 55 is smaller than a dimension in the height direction of the large rectangular part 53. A dimension in the lateral direction of the small rectangular parts 55 is larger than a dimension in the height direction of the small rectangular parts 55.

One of the three small rectangular parts 55, that is, a first small rectangular part 55A is formed at a first end in the lateral direction of the large rectangular part 53 and is on an upper side in the height direction. Another one of the three small rectangular parts 55, that is, a second small rectangular part 55B is formed at a second end in the lateral direction of the large rectangular part 53 and is on the upper side in the height direction.

Still another one of the three small rectangular parts 55, that is, a third small rectangular part 55C is formed at an intermediate part in the lateral direction of the large rectangular part 53 and is on the upper side in the height direction. The third small rectangular part 55C is displaced from a middle part (central part) toward, for example, the first end side in the lateral direction and is on the upper side in the height direction.

The opening 41 of the casing 29 has a part (medium rectangular part) 57 whose lateral dimension is larger than that of the small rectangular part 53 at the central part in the lateral direction. The switch 37 of the control circuit board 17 passes through the medium rectangular part 57 when the control circuit board 17 is arranged in the casing 29.

The opening 41 of the casing 29 will be explained in more detail. An inner side (lower side) of an upper wall of the casing 29 is properly provided with three rectangular protrusions (rectangular parallelepiped protrusions) 59, so that the opening 41 of the casing 29 has the above mentioned shape, i.e., the shape including the large rectangular part 53, three small rectangular parts 55, and medium rectangular part 57.

The housing 33 is formed, as illustrated in FIG. 7 or the like, by folding a rectangular flat plate at two locations into a U-shape when viewed in the longitudinal direction. The U-shaped housing 33 has a rectangular flat bottom plate 61 and a pair of rectangular flat side plates 63. On an upper face of the bottom plate 61 at the first end in the longitudinal direction, there are a plurality of busbar setting parts 65 for setting the busbars 35 at predetermined intervals in the lateral direction.

Each busbar 35 has a busbar body 67, the solderless contact (solderless terminal) 11, and a terminal contact 69. The busbars 35 are arranged on the busbar setting parts 65, respectively as illustrated in FIG. 3. The busbars 35 set on the busbar setting parts 65 are slightly separated from one another, to establish an insulated state.

The control circuit board 17 and the housing 33 with the busbars 35 are inserted into the opening 41 of the casing 29 and are set inside the casing 29, to form the control unit 5, i.e., an integration of the casing 29, housing 33, control circuit board 17, and busbars 35.

In the control unit 5, the terminal contacts 69 of the busbars 35 push and get in contact with a plurality of terminals of the control circuit board 17 and are electrically connected thereto, respectively. Namely, the terminal contact 69 of each busbar 35 has resiliency, to push the terminal of the control circuit board 17 in the control unit 5. In the control unit 5, the solderless contact 11 of each busbar 35 is positioned in the vicinity of the opening 41 of the casing 29 as illustrated in FIG. 6 or the like. The terminal contacts 69 of the busbars 36 are spaced from one another at predetermined intervals in the lateral direction on the inner side of the casing 29 close to the opening 41.

The wire holder 3 is divided as illustrated in FIGS. 5, 11, and the like into the first divided holder (first wire holder structure) 13 and second divided holder (second wire holder structure) 15. The wire holder 3 may be divided into three or more divided holders. In this explanation, the wire holder 3 is divided into the two divided holders 13 and 15.

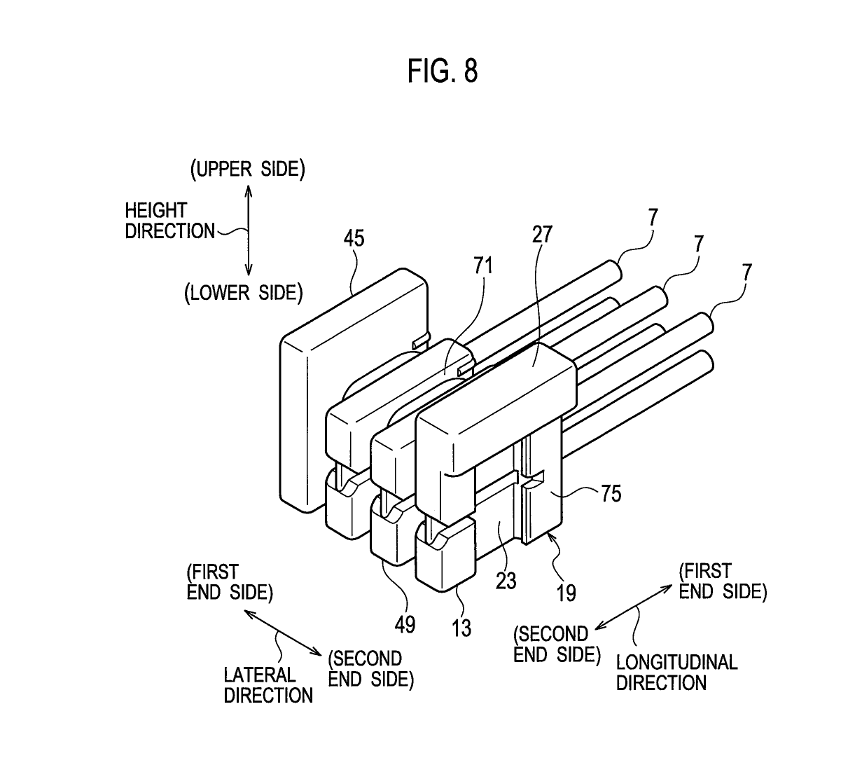

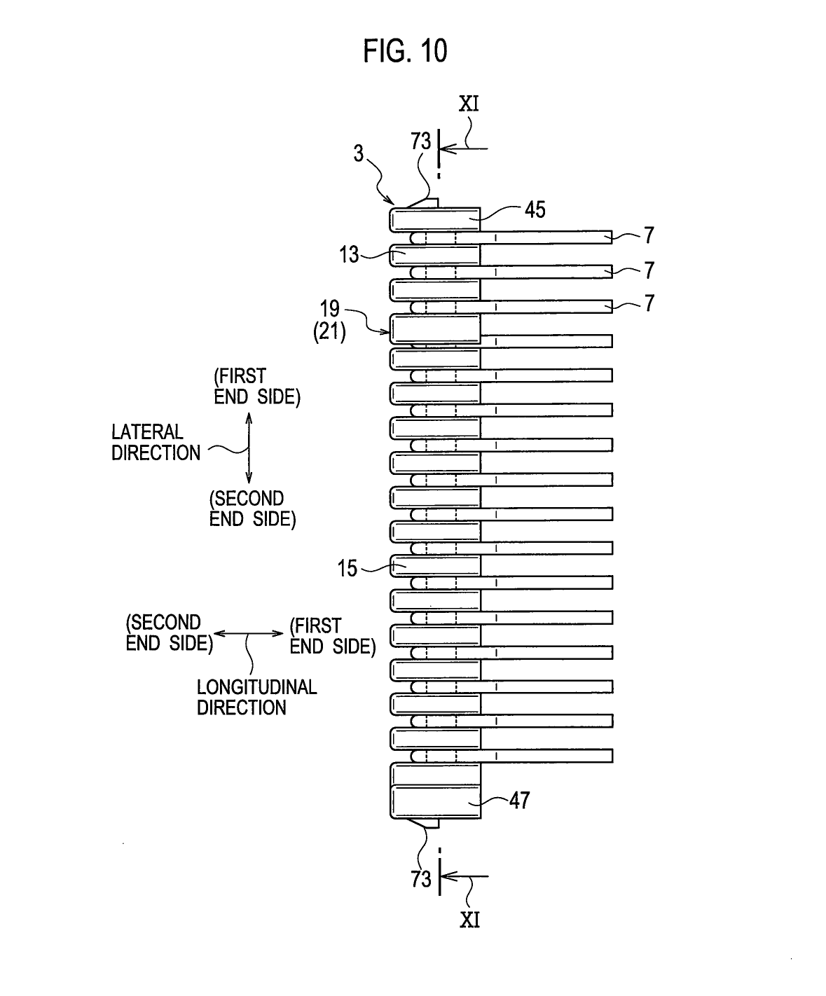

The first divided holder 13 includes, as illustrated in FIG. 8, a first divided holder body 49, a wire holding part 71, the end joint 45, the joint 19, and a latch 73 (refer to FIG. 10). One or a plurality of the wire holding parts 71 are arranged on the first divided holder body 49. If there are a plurality of the wire holding parts 71, they are arranged at predetermined intervals (equal to the intervals of the busbars 35 of the control unit 5) in the lateral direction.

The end joint 45 of the first divided holder 13 is formed at a first end in the lateral direction of the first divided holder body 49. The joint 19 of the first divided holder 13 is formed at a second end in the lateral direction of the first divided holder body 49. The latch of the first divided holder 13, i.e., the latch 73 engaging with the latch hole 39 of the casing 29 of the control unit 5 protrudes at the first end in the lateral direction from the end joint 45 of the first divided holder 13.

The first divided holder body 49 is formed in a cuboid shape elongating in the lateral direction. The wire holding part 71 is, as illustrated in FIG. 3 or the like, a U-shaped groove (a groove having a U-shape when viewed in the lateral direction) formed in the first divided holder body 49. The U-shaped groove of the wire holding part 71 receives and holds the wire 7 that is folded in a U-shape. When the wire 7 is held in the wire holding part 71, the folded part of the wire 7 (a lower part of the U-shape) is on the second end side in the longitudinal direction. When the wire 7 is held in the wire holding part 71, part of the wire 7 extending out of the wire holding part 71 runs on the first end side in the longitudinal direction.

In FIG. 3 or the like, a pair of wires extends on the right side of the wire holder 3 (divided holders 13 and 15). The pair of wires 7 further extends in the right direction and is covered with a cover. With this, the wire holder 3 (the divided holders 13 and 15) realizes the joint incorporating function to be explained later.

As illustrated in FIG. 3, one (for example, upper one) of the pair of extending wires may be cut and the other wire (for example, downside one) may further be extended. An end of the extended single wire is covered with a cover.

The end joint 45 of the first divided holder 13 is formed in a rectangular parallelepiped shape as illustrated in FIG. 8 or the like. A lateral dimension of the end joint 45 of the first divided holder 13 is substantially equal to or slightly larger than a pitch of the wire holding parts 71. A longitudinal dimension of the end joint 45 of the first divided holder 13 is substantially equal to a longitudinal dimension of the first divided holder body 49. A height dimension of the end joint 45 of the first divided holder 13 is slightly larger than a height dimension of the first divided holder body 49.

The end joint 45 of the first divided holder 13 is arranged on the first divided holder body 49 such that both ends in the longitudinal direction of the end joint 45 agree with both ends in the longitudinal direction of the first divided holder body 49 and a lower end in the height direction thereof agrees with a lower end in the height direction of the first divided holder body 49.

The joint 19 of the first divided holder 13 has the joint body (recessed joint structure) 27, a cuboid cut 75, and the cuboid recess 23. An external shape of the joint body 27 of the first divided holder 13 is cuboid like the end joint 45 of the first divided holder 13. The joint body 27 of the first divided holder 13 is arranged on the first divided holder body 49 such that both ends in the longitudinal direction of the joint body 27 agree with both ends in the longitudinal direction of the first divided holder body 49 and a lower end in the height direction thereof agrees with the lower end in the height direction of the first divided holder body 49.

A dimension in the longitudinal direction of the cuboid cut 75 of the joint 19 of the first divided holder 13 is equal to a dimension in the longitudinal direction of the joint body 27 of the first divided holder 13. A dimension in the lateral direction of the cut 75 is smaller than a dimension in the lateral direction of the joint body 27 of the first divided holder 13. A dimension in the height direction of the cut 75 is smaller than a dimension in the height direction of the joint body 27 of the first divided holder 13.

The rectangular parallelepiped cut 75 of the joint 19 of the first divided holder 13 is formed on the joint body 27 of the first divided holder 13 such that both ends in the longitudinal direction thereof agree with both ends in the longitudinal direction of the joint body 27 of the first divided holder 13, the lower end in the height direction thereof agrees with the lower end in the height direction of the joint body 27 of the first divided holder 13, and a second end in the lateral direction thereof agrees with a second end of the joint body 27 of the first divided holder 13.

A dimension in the longitudinal direction of the cuboid recess 23 of the joint 19 of the first divided holder 13 is smaller than the dimension in the longitudinal direction of the joint body 27 of the first divided holder 13 and a dimension in the lateral direction of the recess 23 is smaller than the dimension in the lateral direction of the joint body 27 of the first divided holder 13.

The sum of the dimension in the lateral direction of the cuboid cut 75 of the joint 19 of the first divided holder 13 and the dimension in the lateral direction of the cuboid recess 23 is smaller than the dimension in the lateral direction of the joint body 27 of the first divided holder 13. A dimension in the height direction of the cuboid recess 23 of the joint 19 of the first divided holder 13 is smaller than the dimension in the height direction of the joint body 27 of the first divided holder 13 and is larger than the dimension of the cuboid cut 75 of the joint 19 of the first divided holder 13.

The cuboid recess 23 of the joint 19 of the first divided holder 13 is formed on the joint body 27 of the first divided holder 13 such that it is positioned at the center in the longitudinal direction of the joint body 27 of the first divided holder 13, a lower end in the height direction thereof agrees with the lower end in the height direction of the joint body 27 of the first divided holder 13, and a second end in the lateral direction thereof is in contact with a first end in the lateral direction of the cuboid cut 75 of the joint 19 of the first divided holder 13.

The first divided holder body 49 has a slit into which busbar 35 (solderless contact 11) enters when the wire holder 3 having (holding) the wires 7 is inserted into and arranged in the control unit 5 as illustrated in FIGS. 3 and 11. When the wire holder 3 is inserted into the control unit 5, the solderless contact 11 of the busbar 35 is guided by the slit 77 and is pressed to the wire 3 held with the wire holding part 71.

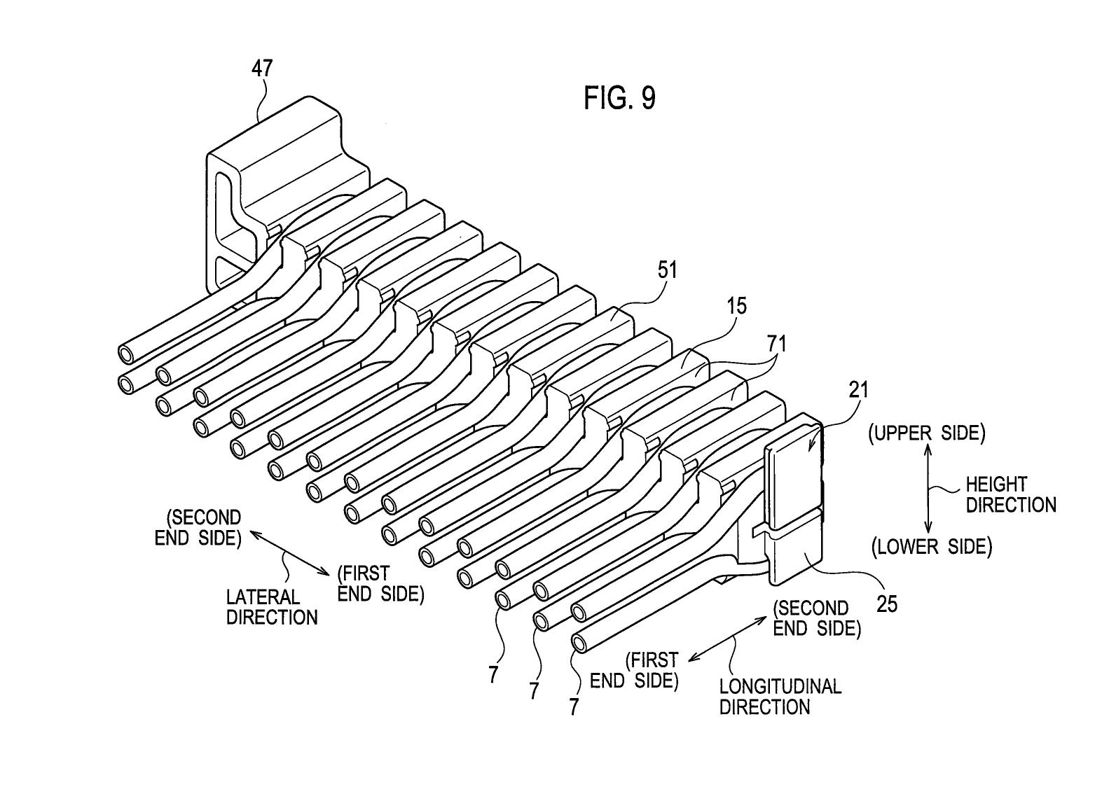

The second divided holder 15 is constituted like the first divided holder 13 except the joint 21, as illustrated in FIG. 9.

Namely, the second divided holder 15 includes a second divided holder body 51, wire holding parts 71, the end joint 47, the joint 21, and the latch 73 as illustrated in FIG. 5. The number of the wire holding parts 71 in the second divided holder 15 is larger than the number of the wire holding parts 71 in the first divided holder 13.

The end joint 47 of the second divided holder 15 is formed at a second end in the lateral direction of the second divided holder body 51. The joint 21 of the second divided holder 15 is formed at a first end in the lateral direction of the second divided holder body 51. The latch of the second divided holder 15, i.e., the latch 73 engaging with the latch hole 39 of the casing 29 of the control unit 5 protrudes at the first end in the lateral direction from the end joint 47 of the second divided holder 15.

In a state that the wires 7 are held with the wire holding parts 71 of the second divided holder 15, part of the wires 7 extending from the wire holding parts 71 runs on the first end side in the longitudinal direction, like the case of the first divided holder 13.

The joint 21 of the second divided holder 15 has a protrusion of a cuboid shape. An external shape of the protrusion 25 of the second divided holder 15 is substantially equal to that of the cuboid recess 23 of the first divided holder 13.

The protrusion 25 of the second divided holder 15 is arranged on the second divided holder body 51 such that it is positioned at a central part in the longitudinal direction of the second divided holder body 51 and a lower end in the height direction thereof agrees with a lower end of the second divided holder body 51.

Setting the wires 7 to the divided holders 13 and 15 and connecting the divided holders 13 and 15 to each other will be explained.

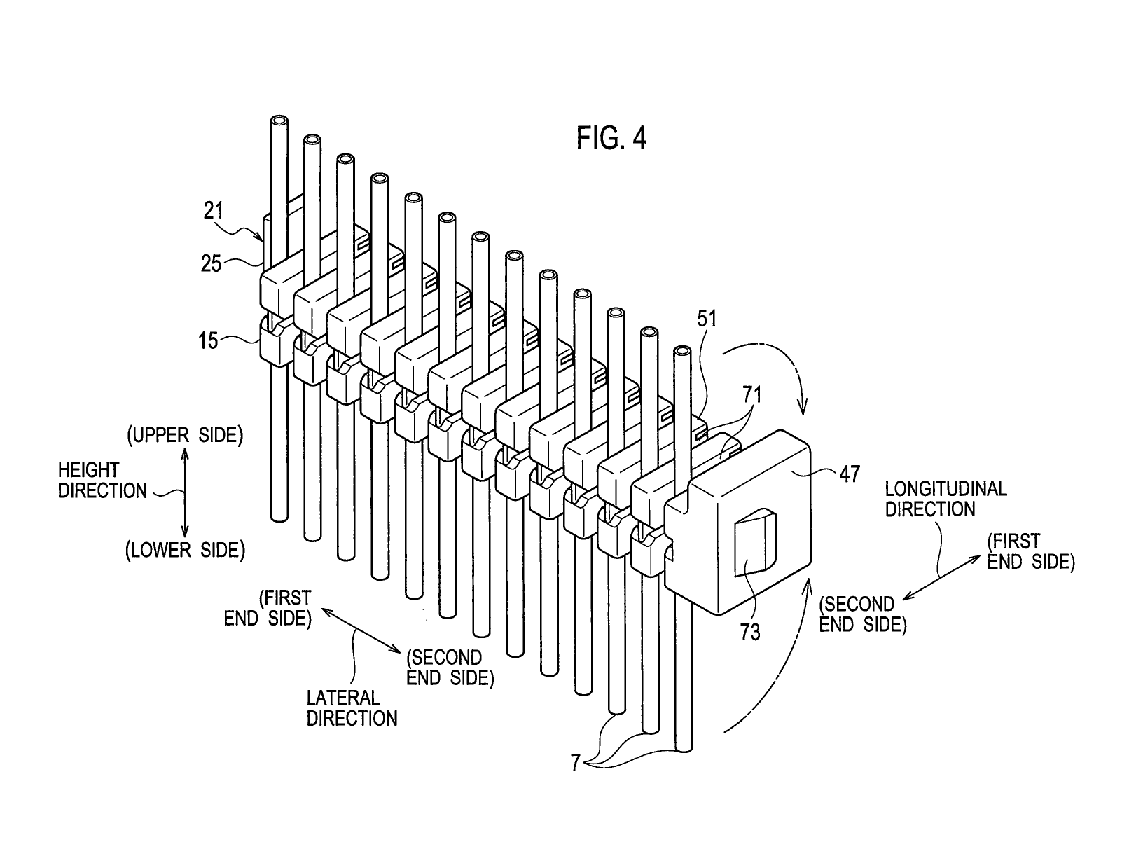

As illustrated in FIG. 4, uncovered wires 7 are set on the wire holding parts 71 of the divided holder 15 (13) and are folded into U-shapes. This completes arranging the wires 7 on the divided holder 15 (13) as illustrated in FIG. 5. The outer diameter of the wire 7 is slightly larger than the width of the wire holding part 71, i.e. the size in the lateral direction of the U-shaped groove, formed in the main bodies 49 and 51 of the divided holders 13 and 15. With this, the wires 7 once set are hardly removed from the divided holders 13 and 15.

The joints 19 and 21 of the divided holders 13 and 15 with the set wires 7 are joined together to connect and integrate the first and second divided holders 13 and 15 with each other. Namely, as indicated with an arrow in FIG. 5, the first divided holder 13 is moved relative to the second divided holder 15 to insert the protrusion 25 of the second divided holder 15 into the recess 23 of the first divided holder 13, thereby integrating the divided holders 13 and 15. The width as a dimension in the longitudinal direction of the recess 23 of the first divided holder 13 is slightly smaller than the width as a dimension in the longitudinal direction of the protrusion 25 of the second divided holder 15, so that the divided holders 13 and 15 once joined are hardly removed from each other.

In the above explanation, the wires 7 are set on the divided holders 13 and 15, and thereafter, the divided holders 13 and 15 are joined together. Instead, the divided holders 13 and 15 may be joined together at first, and thereafter, the wires 7 may be set thereon.

In the wire holder 3 formed by joining the divided holders 13 and 15 together, pitches of the wires 7 as intervals in the lateral direction of the wires 7 are constant and equal to one another. The pitch is also equal to a pitch at the joints 19 and 21. Namely, pitches P1 and P2 illustrated in FIGS. 11 and 13 are equal to each other.

Setting the wire holder 3 with the wires 7 to the control unit 5 will be explained.

As illustrated in FIG. 6, the wire holder 3 is placed apart from the control unit 5 on the first end side in the longitudinal direction of the control unit 5, and as indicated with an arrow, the wire holder 3 is brought closer to the control unit 5 and is inserted into the control unit 5 to a predetermined depth.

Due to this insertion, the latches 73 of the wire holder 3 enter into the latch holes 39 of the control unit 5 to integrate the wire holder 3 and control unit 5 with each other so that the wire holder 3 is hardly removed from the control unit 5. Also, due to the insertion, the solderless contacts 11 of the busbars 35 are pressed to the wires 7 held in the wire holder 3, respectively.

In addition, due to the insertion, the end joints 45 and 47 and joints 19 and 21 of the wire holder 3 enter into the small rectangular parts 55 of the opening 41 of the control unit 5.

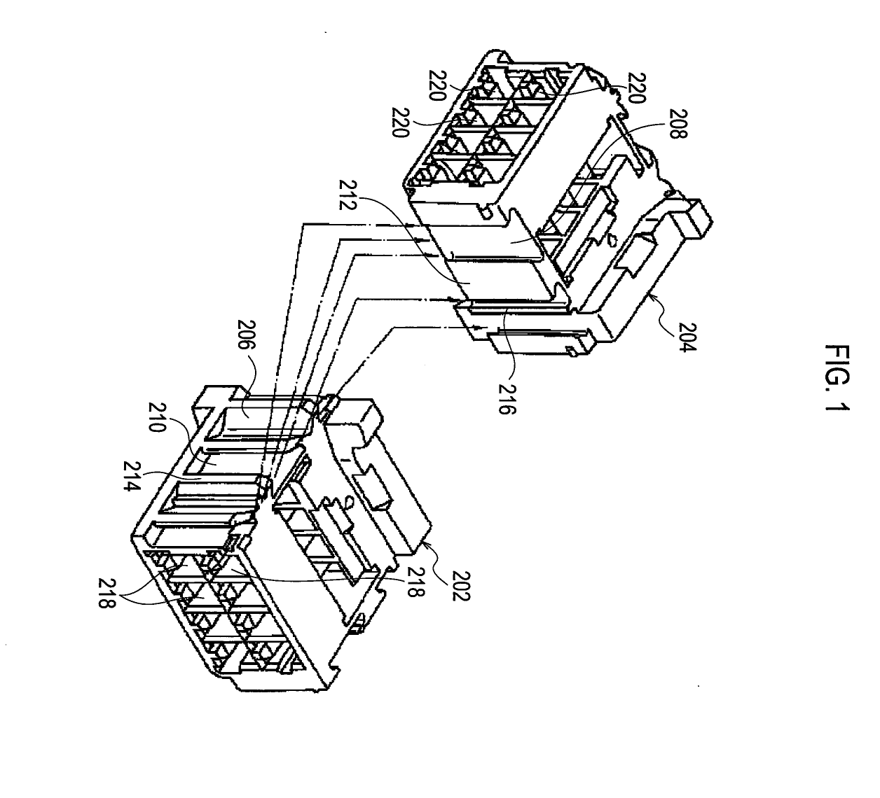

The joint incorporating function will be explained. The joint incorporating function is to realize, for example, a joint function illustrated in FIG. 7 of Japanese Unexamined Patent Application Publication No. H02-46671 on an intermediate joint terminal as illustrated in FIG. 1 of the same patent document.

Namely, extending two wires 7 from each or some of the wire holding parts 71 of the wire holder 3 results in providing the wire holder 3 with the function of a joint 8 illustrated in FIG. 7 of the above-mentioned patent document.

The connector 1 according to the embodiment divides the wire holder 3 into the divided holders 13 and 15, joins them together, and inserts the joined one into the connection part 9 of the control unit 5. With this, the control unit 5 and wire holder 3 are correctly and smoothly connected to each other.

Namely, the wire holder 3 is divided into the divided holders 13 and 15, so that the wires (wire harnesses) 7 are smoothly set to the respective wire holding parts 71 of the divided holders 13 and 15. For example, the first divided holder 13 may have the joint incorporating function and the second divided holder 15 may be connected to single wires that is indicated with reference marks 141 and 142 in FIG. 3 of the above-mentioned patent document. This results in collectively arranging wires of different categories in the divided holders and 15, respectively, and correctly, efficiently, and smoothly setting the wires 7 to the wire holder 3.

After setting the wires 7 to the wire holder 3, the wires 7 of the wire holder 3 are arranged in the control unit 5 with a single inserting operation and are quickly connected to the control unit 5 faster than the related art.

The connector 1 according to the embodiment arranges the control circuit board 17 inside the control unit 5 and provides the wire holder 3 with the joint incorporating function, so that the connector 1 has a simple structure and multiple functions. This eliminates the need of an additional space for the joint incorporating function and control circuit board 17, thereby reducing a space for installing the connector 1 and related devices.

According to the connector 1, the joints 19 and 21 are configured to provide at least one of the pry preventing function and mismating preventing function when the wire holder 3 is inserted into and connected to the connection part 9 of the control unit 5. Namely, the joints 19 and 21 achieve both the function of connecting the divided holders 13 and 15 to each other and the function of pry prevention or mismating prevention, thereby simplifying the structure of the connector 1.

The joints 19 and 21 are arranged out of a central part in the lateral direction of the wire holder 3 and the small rectangular part 55C of the connection part 9 of the control unit 5 is arranged out of a central part in the lateral direction of the control unit 5, to prevent the wire holder 3 from being incorrectly connected to the control unit 5. The joints 19 and 21 of the wire holder 3 enter into the part 55C.

The recessed joint structure 27 of the first divided holder 13 at the joints 19 and 21 of the wire holder 3 protrudes like a small rib having a small lateral dimension from the body 49 of the first divided holder 13. When the wire holder 3 is connected to the control unit 5, the recessed joint structure 27 engages with and is guided along the small rectangular part 55C of the connection part 9 of the control unit 5. Accordingly, the position of the wire holder 3 is stable without a twist when the wire holder 3 is connected to the control unit 5.

According to the connector 1, the joints 19 and 21 of the divided holders 13 and 15 include the joint recess 23 formed at an end of the first divided holder 13 and the joint protrusion 25 formed at an end of the second divided holder 15. Accordingly, the pitches P1 and P2 illustrated in FIG. 11 are equal to each other. Across the joints 19 and 21, the pitches of the wires 7 are smaller than those of the related art, to reduce the size of the wire holder 3 (connector 1) compared with the related art.

The present invention has an effect of providing a connector that is correctly and smoothly connectable to an opposite connector.

1. A connector having a wire holder for attaching wires and a unit part having a connection part, the holder being inserted to connect the wires to solderless terminals arranged at the connection part, wherein
the wire holder is divided into a plurality of divided holders that are joined together for insertion into the connection part.

2. The connector of claim 1, wherein
the unit part incorporates a control circuit board, or the wire holder has a joint incorporating function.

3. The connector of claim 1, wherein
a joint formed on each of the divided holders to join the divided holders to each other has a pry preventing function that functions when the wire holder as an integration of the plurality of divided holders is inserted into or removed from the connection part of the unit part.

4. The connector of claim 1, wherein
a joint formed on each of the divided holders to join the divided holders to each other has a mismating preventing function that functions when the wire holder as an integration of the plurality of divided holders is inserted into the connection part of the unit part.

5. The connector of claim 3, wherein:
the joints of the divided holders include a recessed joint that is formed at an end of one of the divided holders and a protruding joint that is formed at an end of another of the divided holders and is inserted into and joined with the recessed joint; and
a recessed joint structure on which the recessed joint is formed is configured to demonstrate at least one of the pry preventing function and mismating preventing function.

6. The connector of claim 4, wherein:
the joints of the divided holders include a recessed joint that is formed at an end of one of the divided holders and a protruding joint that is formed at an end of another of the divided holders and is inserted into and joined with the recessed joint; and
a recessed joint structure on which the recessed joint is formed is configured to demonstrate at least one of the pry preventing function and mismating preventing function.
